(19) United States
(12) Patent Application Publication
(10) Pub. No.: US 2023/0280443 A1
(43) Pub. Date: Sep. 7, 2023

(54) POSITION MEASURING METHOD AND POSITION MEASURING DEVICE

(71) Applicant: NIPPON TELEGRAPH AND TELEPHONE CORPORATION, Tokyo (JP)

(72) Inventors: Hideyuki TSUBOI, Musashino-shi, Tokyo (JP); Kazuto GOTO, Musashino-shi, Tokyo (JP); Hideki TOSHINAGA, Musashino-shi, Tokyo (JP); Naoki KITA, Musashino-shi, Tokyo (JP); Takeshi ONIZAWA, Musashino-shi, Tokyo (JP)

(73) Assignee: NIPPON TELEGRAPH AND TELEPHONE CORPORATION, Tokyo (JP)

(21) Appl. No.: 18/017,999

(22) PCT Filed: Jul. 27, 2020
(86) PCT No.: PCT/JP2020/028680

§ 371 Date: Jan. 25, 2023

(51) Int. Cl. G01S 5/16; G01S 17/46

(52) U.S. Cl. CPC G01S 5/16; G01S 17/46

(57) ABSTRACT

A position measurement method includes a point group data generation step of generating point group data indicating a position of an object around a predetermined route measured by a measurement unit moving along the route, an acquisition step of acquiring a plurality of pieces of point group data generated by being measured at different timings with respect to the same route, and a position identification step of identifying a detection target position indicating a position of a predetermined object present around the route on the basis of a difference in the position for each of the plurality of pieces of point group data.

### TECHNICAL FIELD

The present invention relates to a position measurement method and a position measurement device.

### BACKGROUND ART

Recently, the importance of maintenance and inspection of various infrastructure facilities such as streetlights, electricity poles, and traffic lights has increased. In Japan, particularly, there were many infrastructure facilities installed from 1950 to 1970 including a high economic growth period. In many of these infrastructure facilities, deterioration has progressed. The standard of the service life of these infrastructure facilities is said to be approximately 50 years. Therefore, the number of infrastructure facilities exceeding this standard of the service life has been increasing year by year. Many of such infrastructure facilities are managed by local governments or companies. Local governments or companies need to periodically perform maintenance and inspection of such infrastructure facilities.

In Japan, it has been predicted that the decrease in population will continue for 30 to 50 years due to a declining birthrate and a growing proportion of elderly people. As the population decreases, the numbers of infrastructure facilities with reduced frequency of use and infrastructure facilities with difficulty in performing maintenance and inspection requiring much manpower have been increasing. Therefore, it is required to further improve the efficiency of maintenance and inspection of infrastructure facilities.

As an efficient maintenance and inspection method, there is a method of using, for example, a mobile mapping system (MMS). An MMS is a system for performing environment measurement over a wide range by moving a measurement device such as a laser radar and a positioning device such as a global positioning system (GPS) mounted on a moving body such as a vehicle. An MMS measures an environment of, for example, an urban area. The MMS radiates laser light to the surroundings and receives reflected light reflected on the surface of an object. Accordingly, the MMS generates point group data indicating a three-dimensional position of an object (hereinafter referred to as “three-dimensional point group data”), for example. Recently, the development of technology for detecting a measurement target such as an infrastructure facility from three-dimensional point group data generated by the MMS and analyzing the state of the measurement target has progressed. For example, a point group analysis processing device described in PTL 1 collects three-dimensional point group data and estimates the position and inclination of a columnar object such as an electric pole.

### CITATION LIST

### Patent Literature

[PTL 1] Japanese Patent Application Publication No. 2014-153336

### SUMMARY OF INVENTION

### Technical Problem

In the maintenance and inspection of various infrastructure facilities, particularly, highly accurate position measurement is required. Highly accurate position measurement mentioned here is, for example, measurement requiring measurement accuracy within units of millimeters. Maintenance and inspection requiring highly accurate position measurement include, for example, maintenance and inspection of an expansion gap which is a joint between rails of a railway. Measurement accuracy in at least millimeter units is required for measurement of the length of an expansion gap.

However, in the present MMS, even if a highly accurate laser radar is used, measurement accuracy is several centimeters in position measurement of objects which are several meters apart. Depending on conditions, the measurement accuracy may be in units of ten or several centimeters. Therefore, the present MMS has a problem that it is difficult to utilize the present MMS for maintenance and inspection of infrastructure facilities requiring highly accurate measurement such as maintenance and inspection of an expansion gap of the rails.

In view of the above circumstances, an object of the present invention is to provide a position measurement method and a position measurement device capable of improving accuracy of measurement of a position of an object.

### Solution to Problem

One aspect of the present invention is a position measurement method including: a point group data generation step of generating point group data indicating a position of an object around a predetermined route measured by a measurement unit moving along the route; an acquisition step of acquiring a plurality of pieces of point group data generated by being measured at different timings with respect to the same route; and a position identification step of identifying a detection target position indicating a position of a predetermined object present around the route on the basis of a difference in the position for each of the plurality of pieces of point group data.

One aspect of the present invention is a position measurement device including: an acquisition unit configured to acquire a plurality of pieces of point group data which indicate positions of objects around a predetermined route measured by a measurement unit moving along the route and are generated by being measured at different timings with respect to the same route; and a position identification unit configured to identify a detection target position indicating a position of a predetermined object present around the route on the basis of a difference in the position for each of the plurality of pieces of point group data.

### Advantageous Effects of Invention

According to the present invention, it is possible to improve measurement accuracy of a position of an object.

### BRIEF DESCRIPTION OF DRAWINGS

FIG. 1 is a diagram for describing a position measurement method in a first embodiment of the present invention.

FIG. 2 is a diagram showing an example of an expansion gap in the first embodiment of the present invention.

FIG. 3 is a diagram showing position data acquisition positions moving with the movement of a train in the first embodiment of the present invention.

FIG. 4 is a diagram showing an interval between two adjacent measurement positions in the first embodiment of the invention.

FIG. 5 is a diagram showing superposition of three-dimensional point group data by a position measurement system in the first embodiment of the present invention.

FIG. 6 is a plan view of a range of interest in the first embodiment of the present invention viewed from above.

FIG. 7 is a diagram showing superposition of three-dimensional point group data by the position measurement system in the first embodiment of the present invention.

FIG. 8 is a block diagram showing a functional configuration of the position measurement system in the first embodiment of the present invention.

FIG. 9 is a flowchart showing an operation of a position measurement device in the first embodiment of the present invention.

FIG. 10 is a diagram for describing a position measurement method in a modified example of the first embodiment of the present invention.

FIG. 11 is a diagram for describing processing of identifying the position and amount of an expansion gap by a position measurement system in a second embodiment of the present invention.

FIG. 12 is a diagram for describing processing of identifying the position and amount of an expansion gap by the position measurement system in the second embodiment of the present invention.

FIG. 13 is a flowchart showing an operation of a position measurement device in the second embodiment of the present invention.

### DESCRIPTION OF EMBODIMENTS

Hereinafter, a position measurement method and a position measurement device according to embodiments will be described with reference to the drawings.

In a position measurement method according to an embodiment of the present invention, a measurement device mounted on a moving body moves along a predetermined route. The measurement device sequentially measures the positions of surrounding objects while moving. The measurement device generates point group data based on measurement results. The position measurement device acquires point group data generated by the measurement device. At this time, the position measurement device acquires a plurality of pieces of point group data generated by performing measurement a plurality of times on the same route. The position measurement device identifies a predetermined detection target position on the basis of differences in measurement positions for each of the plurality of pieces of point group data. A measurement position mentioned here is a position on the surface of a surrounding object measured by the measurement device.

Since there are variations in measurement positions in the plurality of pieces of point group data, the position measurement device can identify the detection target position using a larger amount of point group data in a measurement target range. Accordingly, the position measurement device can improve measurement accuracy of the position of an object.

### First Embodiment

Hereinafter, a first embodiment of the present invention will be described.

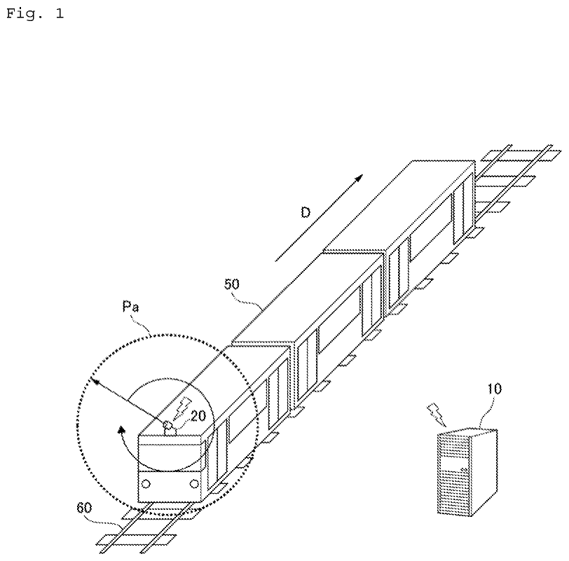

FIG. 1 is a diagram for describing a position measurement method in the first embodiment of the present invention. In the present embodiment, a moving body is a train 50 and a predetermined route is a track including rails 60.

In the present embodiment, the track is, for example, a ballast track. The ballast track is a track bed having a structure in which ballast such as crushed stones and gravel is laid on a track bed on a roadbed, sleepers are arranged on the ballast, and rails are laid on the sleepers. Since the ballast track efficiently disperses a load from sleepers and transmits the load to a roadbed, the ballast track has advantages of low vibration, low noise, good riding comfort, good drainage, low construction cost, and the like. On the other hand, the ballast track has disadvantages that deformation (track displacement) is likely to occur and time and labor are taken for maintenance because it has low strength. In particular, a lot of man-hours are required for work such as correction of track deviation.

A measurement device 20 is mounted on the train 50 which is a moving body. The train 50 travels on the track in a traveling direction D shown in FIG. 1, for example. The measurement device 20 is installed, for example, at a position at the upper center of the rearmost part of the train 50. The measurement device 20 moves as the train 50 travels on the track. The measurement device 20 sequentially measures the positions of surrounding objects while moving. The measurement device 20 generates three-dimensional point group data based on measurement results. The generated point group data is not limited to three-dimensional point group data and may be two-dimensional point group data. The measurement device 20 transmits the generated three-dimensional point group data to a position measurement device 10, for example, wirelessly.

The measurement device 20 measures the surrounding of the same travel route a plurality of times by the train 50 traveling on the same travel route a plurality of times. Accordingly, a plurality of pieces of three-dimensional point group data in the same travel route are generated.

A position measurement system 1 is realized by the position measurement device 10 and the measurement device 20. In the present embodiment, the position measurement system 1 is a mobile mapping system (MMS) that generates and analyzes three-dimensional point group data with respect to surrounding objects. In the present embodiment, a laser radar (light detection and ranging, laser imaging detection and ranging (LIDAR)) is mounted on the measurement device 20 as measurement equipment.

The position measurement device 10 acquires a plurality of pieces of three-dimensional point group data on the same travel route transmitted from the measurement device 20. The position measurement device 10 identifies a predetermined detection target position on the basis of differences in measurement positions obtained by the measurement device 20 for each of the plurality of pieces of point group data.

The position measurement system 1 in the present embodiment is a system for detecting an abnormality of a detection target by identifying a predetermined detection target position for the purpose of maintenance and inspection of railway infrastructure. In the present embodiment, a detection target is the rails 60.

For example, in the ballast track, two parallel rails 60 on the left and right are connected by sleepers and fixed by ballast such as crushed stones or gravel. Accordingly, the train 50 having a weight of several tens of tons can travel at a high speed. The two rails 60 are each formed by arranging a plurality of rails in series. For example, in the case of using fixed-length rails, one rail 60 is constructed by arranging rails having a length of 25 [m] in series in Japan.

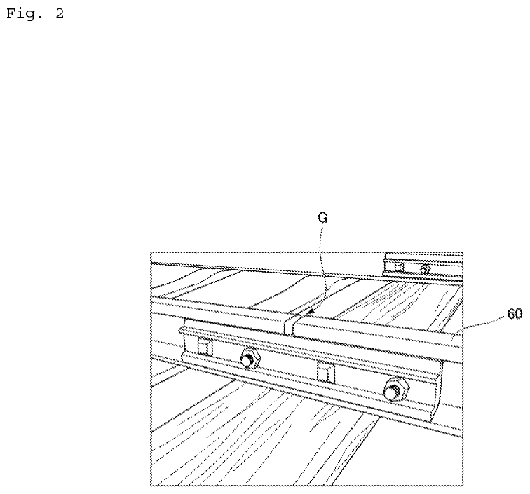

Rails expand and contract by temperature change accompanying, for example, seasonal change, and particularly the length in the longitudinal direction changes significantly. The lengths of rails in the longitudinal direction increase as the temperature increases and decrease as the temperature decreases. Therefore, an expansion gap is generally provided at a joint between rails arranged in series. The expansion gap is a clearance between rails. FIG. 2 is a diagram showing an example of an expansion gap G. Hereinafter, the length of the expansion gap G is referred to as “expansion gap amount.”

When a set expansion gap amount is excessively small, particularly when rails expand in summer, the expansion gap G is eliminated, and thus neighboring rails arranged in series are pressed against each other. Accordingly, the rails 60 are overhung, and thus a derailment accident may occur in some cases and safety is reduced.

On the other hand, when the set expansion gap amount is excessively large, particularly when the rails contract in winter, neighboring rails arranged in series are separated from each other more than necessary. Accordingly, the impact when the wheels of the train 50 come into contact with the end of the rails increases, and thus riding comfort is deteriorated. Further, this increase in the impact causes damage to the end parts of rails, the joint bolt connecting rails, joint plates, and the like.

From the above, it is necessary to manage the expansion gap amount such that it is always maintained to have a suitable length. The position measurement system 1 in the present embodiment is a system for measuring an expansion gap amount. For example, the expansion gap amount when rails having a length of 10 [m] are used is managed such that it is within a range of 1.6 [mm] to 7.9 [mm] in accordance with temperature change. Therefore, in measurement of the expansion gap amount, measurement accuracy at least in units of millimeters, preferably, 0.1 millimeters is required.

The position measurement system 1 in the present embodiment measures an expansion gap amount using a plurality of pieces of three-dimensional point group data generated by performing measurement on the same route a plurality of times. Accordingly, the position measurement system 1 can measure the expansion gap amount with higher accuracy as compared to a case in which the expansion gap amount is measured using only one piece of three-dimensional point group data generated by one-time measurement.

In the present embodiment, the position measurement system 1 is a system for measuring the expansion gap amount, but the present invention is not limited thereto. For example, the position measurement system 1 may be a system for measuring track displacement. The track displacement is a change in a rail position. In the ballast track, in particular, the position of the rails 60 tends to gradually change due to repeated traveling of the train 50, for example.

The track displacement includes height displacement, passing displacement, a gauge displacement, level displacement, planar displacement and composite displacement. The height displacement is vertical displacement of a rail. The height displacement causes vertical vibration and pitching of vehicles. The passing displacement causes lateral vibration of vehicles. When the passing displacement is excessively large, rolling of a vehicle is induced, and in some cases, there is a possibility of this leading to a derailment accident.

The gauge displacement is a difference between the actual clearance (gauge) between the two rails 60 and a design value. If the gauge is excessively wide, the wheels fall between the two rails 60, and in some cases, there is a possibility of this leading to a derailment accident. The level displacement is a difference between the heights of the two rails 60. If the level displacement is excessively large, rolling of a vehicle may be induced, and in some cases, there is a possibility of leading to a derailment accident as in the passing displacement.

The planar displacement is a difference between level displacements of two points separated by a certain distance. Generally, a truck that is a railway vehicle includes two axles and four wheels. The planar displacement represents the torsion of a surface composed of four points on the rail in contact with wheels. If the planar displacement is excessively large, one of the four wheels is lifted, and in some cases, there is a possibility of leading to a derailment accident. The composite displacement is an index defined to prevent passing displacement and level displacement from being continuously present at the same place. Rolling of a vehicle due to passing displacement and rolling of the vehicle due to level displacement generate resonance of the vehicle, and thus rolling may become extremely large. Resonance of a vehicle may lead to a derailment accident in some cases.

The magnitude of the track displacement is managed in a range of, for example, 3 [mm] to 30 [mm]. Accordingly, in the measurement of the track displacement, measurement accuracy at least in units of millimeters is required in general as in the measurement of the expansion gap. The position measurement system 1 in the present embodiment can measure the track displacement using a plurality of pieces of three-dimensional point group data generated by performing measurement on the same route a plurality of times. Accordingly, the position measurement system 1 can measure the track displacement with higher accuracy as compared to a case in which the track displacement is measured using only one piece of three-dimensional point group data generated by one-time measurement.

Hereinafter, a case where the position measurement system 1 measures an expansion gap amount will be described. As shown in FIG. 1, the measurement device 20 is installed at the upper part of the rearmost part of the train 50. The measurement device 20 is provided with a laser radar. The position measurement system 1 measures the surroundings of the track on which the train 50 travels by the laser radar and generates position data indicating positions of objects present around the track.

The position measurement system 1 performs measurement in each direction on a face (hereinafter referred to as a “cross section”) perpendicular to the traveling direction of the train 50. The position measurement system 1 rotates the measurement direction of the laser radar by 360 degrees along the cross section while the train 50 is traveling, as shown in FIG. 1. The laser radar is installed at the end of the rearmost part of the train 50, and thus can uniformly measure the direction in 360 degrees along the cross section.

FIG. 1 shows a position data acquisition position Pa which is a set of acquisition positions of position data acquired by the laser radar. In practice, a position at which position data is acquired is a position at which laser emitted from the laser radar hits the surface of an object. Therefore, the position data acquisition position Pa is not actually formed into a true circle as shown in FIG. 1. However, in order to make the description easy to understand, the position data acquisition position Pa is represented in a true circle in each figure.

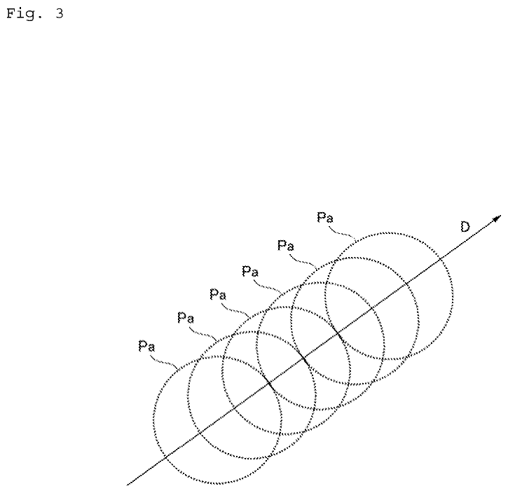

FIG. 3 is a diagram conceptually showing position data acquisition positions Pa which move as the train 50 travels. The position data acquisition position Pa is a set of positions on the circumferences of a plurality of circles having a locus through which the laser radar passes as a center axis. In practice, the position data acquisition position Pa is a set of positions on spiral lines having a locus through which the laser radar passes as a center axis.

In the following description, however, in order to facilitate understanding of the description, the position data acquisition positions Pa obtained by measurement by the laser radar are assumed to be discretely located. That is, it is assumed that a plurality of position data acquisition positions Pa are arranged at equal intervals as shown in FIG. 3.

When a measurement direction of the laser radar coincides with a direction in which the rails 60 are present (that is, a direction almost immediately below), a laser emitted from the laser radar hits the surface of the rails 60. However, at the timing at which the measurement direction of the laser radar corresponds to the expansion gap G of the rails 60, the emitted laser hits the surface of the sleepers or the ground. That is, the position in the measured height direction is different between a timing when a measurement target position is the surface of a rail and a case where the measurement target position is the expansion gap G. The position measurement system 1 can estimate the position of the expansion gap G and the length of the expansion gap G on the basis of change in the position in the height direction of position data measured in the direction in which the rails 60 are present.

The current high-precision laser radar can measure measurement positions of about 1,000,000 points per second. In order to simplify the description, it is assumed that the laser radar can measure measurement positions of 720,000 points per second in the present embodiment. Further, it is assumed that the traveling speed of the train 50 is 72 [km] per hour, that is, 20 [m] per second in the present embodiment. Further, it is assumed that the rotational speed of the laser radar is 200 [Hz] in the present embodiment. This rotational speed is a value equivalent to that of the current high-precision laser radar.

In this case, the laser radar advances by 10 [cm] (=20 [m] x 100 [cm] 200 [Hz]) in the traveling direction D of the train 50 each time it rotates. Therefore, the interval between position data acquisition positions Pa in the traveling direction D of the train 50 is 10 [cm].

As described above, the laser radar can measure the measurement positions of 720,000 points per second, and the rotational speed of the laser radar is 200 [Hz]. Therefore, the laser radar measures measurement positions of 3600 points (=720,000 [points/second] 200 [Hz]) per rotation. In addition, the angle between two adjacent measurement positions on the same cross section is 0.1 [deg] (=360 [deg] 3600 [points]).

Here, it is assumed that the installation height of the laser radar is 3 [m] from the position of the rails 60. In this case, the interval between two adjacent measurement positions on the same cross section at a position 3 [m] away from the laser radar (that is, the interval between two measurement positions measured continuously) is 0.52 [cm] (=3 [m] x 100 [cm] x))tan(0.1°.

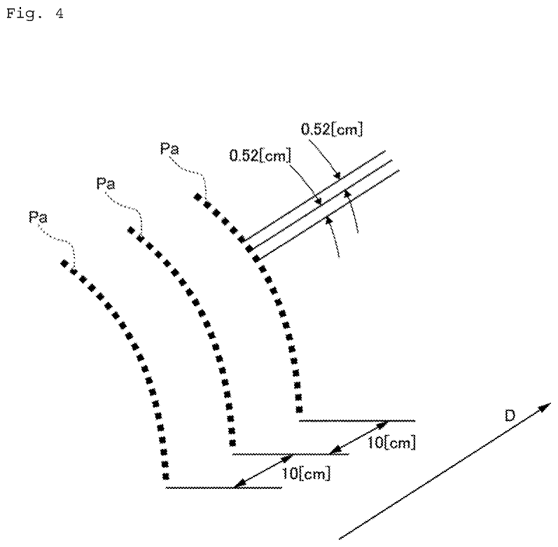

FIG. 4 is a diagram showing the interval between two adjacent measurement positions. According to the above calculation, three-dimensional point group data having an accuracy of 10 [cm] in the traveling direction D of the train 50 and 0.52 [cm] in the cross-sectional direction can obtained through the laser radar in the present embodiment.

However, the expansion gap amount that is a measurement target of the position measurement system 1 in the present embodiment represents a length in the traveling direction D of the train 50. Therefore, it is impossible to correctly measure the expansion gap amount with the three-dimensional point group data having the accuracy of 10 [cm] in the traveling direction D of the train 50. Therefore, the position measurement system 1 in the present embodiment increases the density of three-dimensional point group data by superposing a plurality of pieces of three-dimensional point group data generated by performing measurement on the same route a plurality of times. Accordingly, the position measurement system 1 can measure the expansion gap amount requiring measurement accuracy at least in units of millimeters.

Hereinafter, superposition of a plurality of pieces of three-dimensional point group data and improvement of the density of three-dimensional point group data according to the superposition by the position measurement system 1 in the present embodiment will be described.

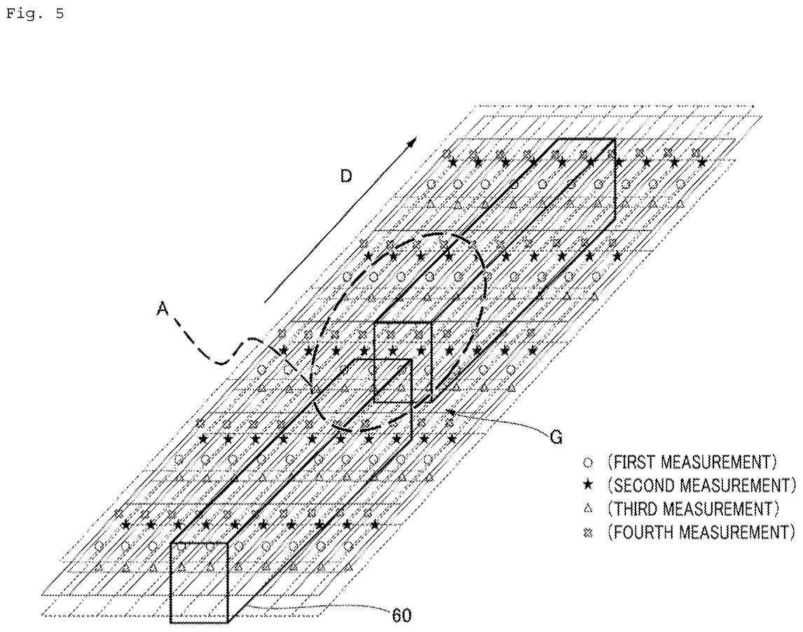

FIG. 5 is a diagram showing superposition of three-dimensional point group data by the position measurement system 1 in the first embodiment of the present invention. FIG. 5 shows, as an example, a state in which four pieces of three-dimensional point group data generated by performing four measurements on the same route are superposed. Measurement positions included in the three-dimensional point group data are different from each other in the four pieces of three-dimensional point group data.

This is caused by, for example, a difference (variation) between measurement start positions. It is also possible to include other factors of variation in measurement conditions, such as slight lateral displacement due to vibration of the train 50 during traveling and differences in the traveling speed of the train 50. Since the number of measurement positions becomes four times at the maximum when measurement is performed on the same route four times due to such variation, for example, the density of the three-dimensional point group data is improved. The position measurement system 1 in the present embodiment estimates the position and the amount of the expansion gap using the three-dimensional point group data having the improved density.

In FIG. 5, measurement positions included in three-dimensional point group data obtained by the first measurement are indicated by white circles. Similarly, measurement positions included in three-dimensional point group data obtained by the second to fourth measurements are indicated by a black-colored star mark, a white triangular mark, and a white x mark, respectively. In measurement positions obtained at the same measurement time (that is, measurement positions indicated by the same mark in FIG. 5), the distance between two adjacent measurement positions is about 10 [cm] in the traveling direction D of the train 50 and about 0.52 [cm] in the cross-sectional direction, as described above.

Further, in FIG. 5, a region including the expansion gap G of the rails 60 is represented in an elliptical shape by a dotted line. Hereinafter, this region is referred to as a “range A of interest.”

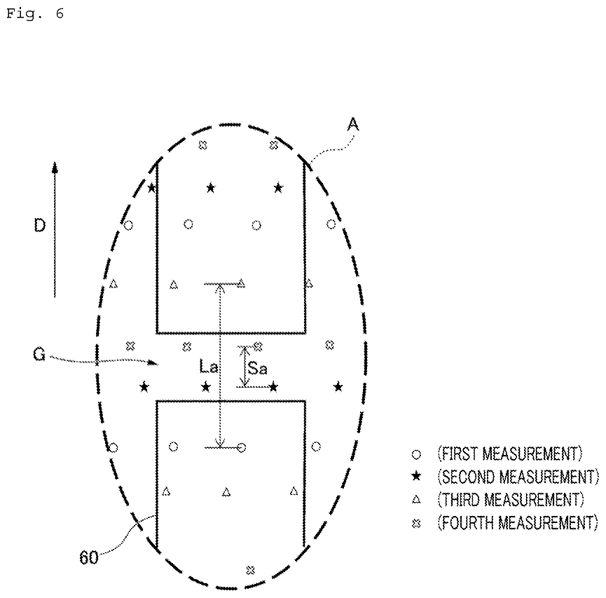

FIG. 6 is a plan view of the range A of interest shown in FIG. 5 viewed from above. As shown in FIG. 6, in the range of the expansion gap G, measurement positions indicated by the black-colored star mark and measurement positions indicated by the white x mark are present, and measurement positions indicated by a white round mark and measurement positions indicated by the white triangular mark are not present. That is, only in the second measurement and the fourth measurement, measurement positions within the range of the expansion gap G are included.

Position data in the height direction greatly differs between a case where a measurement position is the surface of a rail 60 and a case where the measurement position is a position other than the surface of the rail 60 (also including a case in which the measurement position is within the range of the expansion gap G). That is, a measurement position on the surface of the rail 60 is located at a position (position closer to the laser radar) higher than a measurement position other than the surface of the rail 60 (that is, a measurement position at the height of the sleepers). Therefore, the position measurement system 1 in the present embodiment can easily determine whether or not a measurement position is a position on the surface of the rail 60.

The position measurement system 1 can recognize that the expansion gap amount of the expansion gap G of the rails 60 is longer than at least a length between a position in the traveling direction D of a measurement position indicated by the black-colored star mark and a position in the traveling direction D of a measurement position indicated by the white x mark. That is, the position measurement system 1 can recognize that a lower limit value of the expansion gap amount is a length Sa shown in FIG. 6.

In addition, the position measurement system 1 can recognize that the expansion gap amount of the expansion gap G of the rails 60 is shorter than at most a length between a position in the traveling direction D of a measurement position indicated by the white round mark and a position in the traveling direction D of a measurement position indicated by the white triangular mark. That is, the position measurement system 1 can recognize that an upper limit value of the expansion gap amount is a length La shown in FIG. 6.

In this manner, the position measurement system 1 in the present embodiment can narrow the expansion gap amount using a plurality of pieces of three-dimensional point group data generated by performing measurement on the same route a plurality of times. Although FIG. 5 and FIG. 6 show an example of a case where measurement is performed four times, the number of measurements can be further increased, and the expansion gap amount can be further narrowed as a larger amount of three-dimensional point group data is superposed. Accordingly, an expansion gap amount more approximated to the actual value is obtained.

Although it is assumed that three-dimensional point group data of four measurements is used here in order to make the description easy to understand, a larger number of measurements are required in practice. This is because the expansion gap amount is set, for example, in the range of 1.6 [mm] to 7.9 [mm] and management at least in units of millimeters is required, as described above. On the other hand, with the laser radar in the present embodiment, only three-dimensional point group data having an accuracy of 10 [cm] in the traveling direction D of the train 50 can be obtained.

Accordingly, a case in which no measurement position is present within the range of the expansion gap G only by four measurements, for example, may also be conceived. Therefore, it is difficult to perform management in units of millimeters using only three-dimensional point group data obtained by four measurements. In practice, it is necessary to use a large amount of three-dimensional point group data obtained by performing measurement at least about 10 times, preferably about 100 times.

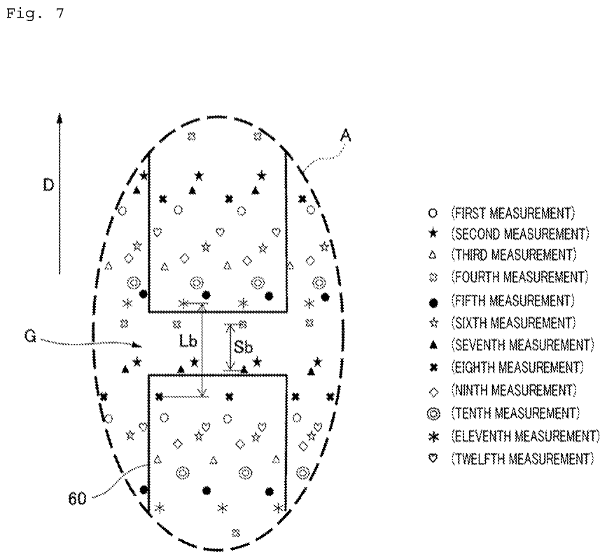

For example, when twelve pieces of three-dimensional point group data generated by performing measurement on the same route twelve times are superposed, superposition is as shown in FIG. 7.

FIG. 7 is a diagram showing superposition of three-dimensional point group data by the position measurement system 1 in the first embodiment of the present invention. FIG. 7 shows a state in which the range A of interest including the expansion gap G of the rail 60 is viewed from above, as in FIG. 6.

In FIG. 7, measurement positions included in three-dimensional point group data obtained by the first to fourth measurements are indicated by a white round mark, a black-colored star mark, a white triangular mark, and a white x mark, respectively, as in FIG. 5 and FIG. 6. Further, measurement positions included in three-dimensional point group data obtained by the fifth to twelfth measurements are indicated by a black-colored round mark, a white star mark, a black-colored triangular mark, a black-colored x mark, a white square mark, a double-round mark, an asterisk mark, and a white heart mark, respectively. In measurement positions obtained at the same measurement time (that is, measurement positions indicated by the same mark in FIG. 7), the distance between two adjacent measurement positions is about 10 [cm] in the traveling direction D of the train 50 and about 0.52 [cm] in the cross-sectional direction, as described above.

As shown in FIG. 7, measurement positions indicated by the black-colored triangular mark, measurement positions indicated by the black-colored star mark, and measurement positions indicated by the white x mark are present in the range of the expansion gap G. Further, measurement positions indicated by the white round mark, measurement positions indicated by the white triangular mark, measurement positions indicated by the black-colored round mark, measurement positions indicated by the white star mark, measurement positions indicated by the black-colored x mark, measurement positions indicated by the white square mark, measurement positions indicated by the double-round mark, measurement positions indicated by the asterisk mark, and measurement positions indicated by the white heart mark are not present in the range of the expansion gap G. That is, only in the second measurement, the fourth measurement, and the seventh measurement, measurement positions are included within the range of the expansion gap G.

As described above, position data in the height direction greatly differs between a case where a measurement position is the surface of the rails 60 and a case where the measurement position is a position other than the surface of the rails 60 (also including a case where the measurement position is within the range of the expansion gap G). That is, a measurement position on the surface of the rails 60 is located at a position (position closer to the laser radar) higher than a measurement position other than the surface of the rails 60 (that is, a measurement position at the height of the sleepers). Therefore, the position measurement system 1 in the present embodiment can easily determine whether or not a measurement position is a position on the surface of the rail 60.

As described above, measurement positions (indicated by the black-colored star mark) obtained by the second measurement, measurement positions (indicated by the white x mark) obtained by the fourth measurement, and measurement positions (indicated by the black-colored triangular mark) obtained by the seventh measurement are present within the range of the expansion gap G. Among these, the measurement position closest to a rail on the rear side in the traveling direction D is a measurement position (indicated by the black-colored triangular mark) obtained by the seventh measurement, as shown in FIG. 7. On the other hand, the measurement position closest to the rail on the front side in the traveling direction D is a measurement position (indicated by the white x mark) obtained by the fourth measurement, as shown in FIG. 7.

The position measurement system 1 can estimate a lower limit value of the expansion gap amount of the expansion gap G of the rails 60 on the basis of two measurement positions closest to the front and rear rails having the expansion gap G sandwiched therebetween. Specifically, the position measurement system 1 can recognize that the expansion gap amount of the expansion gap G of the rails 60 is longer than at least a length between a position in the traveling direction D of a measurement position indicated by the black-colored star mark and a position in the traveling direction D of a measurement position indicated by the white x mark. That is, the position measurement system 1 can recognize that the lower limit value of the expansion gap amount is a length Sb shown in FIG. 7.

Further, among measurement positions on the surface of the rails on the rear side in the traveling direction D, the measurement position closest to the expansion gap G is a measurement position (indicated by the black-colored x mark) obtained by the eighth measurement, as shown in FIG. 7. In addition, among measurement positions on the surface of the rails on the front side in the traveling direction D, the measurement position closest to the expansion gap G is a measurement position (indicated by the asterisk mark) obtained by the eleventh measurement, as shown in FIG. 7.

The position measurement system 1 can estimate an upper limit value of the expansion gap amount of the expansion gap G of the rails 60 on the basis of the measurement positions on the front and rear rails having the expansion gap G sandwiched therebetween, which are closest to the expansion gap G. Specifically, the position measurement system 1 can recognize that the expansion gap amount of the expansion gap G of the rails 60 is shorter than at most a length between a position in the traveling direction D of a measurement position indicated by the black-colored x mark and a position in the traveling direction D of a measurement position indicated by the asterisk mark. That is, the position measurement system 1 can recognize that the upper limit value of the expansion gap amount is a length Lb shown in FIG. 7.

As can be ascertained from comparison between FIG. 6 and FIG. 7, a difference between the upper limit value and the lower limit value of the expansion gap amount is further narrowed in FIG. 7 showing a case where the number of times of measurement is larger. That is, the length Sb, which is the lower limit value of the expansion gap amount shown in FIG. 7, is greater than the length Sa, which is the lower limit value of the expansion gap amount shown in FIG. 6. The length Lb, which is the upper limit value of the expansion gap amount shown in FIG. 7, is greater than the length La, which is the upper limit value of the expansion gap amount shown in FIG. 6. By increasing the number of times of measurement in this manner, the expansion gap amount can be further narrowed as a larger amount of three-dimensional point group data is superposed. Accordingly, an expansion gap amount more approximated to the actual value is obtained.

[Functional Configuration of Position Measurement System]

Hereinafter, a functional configuration of the position measurement system 1 in the present embodiment will be described.

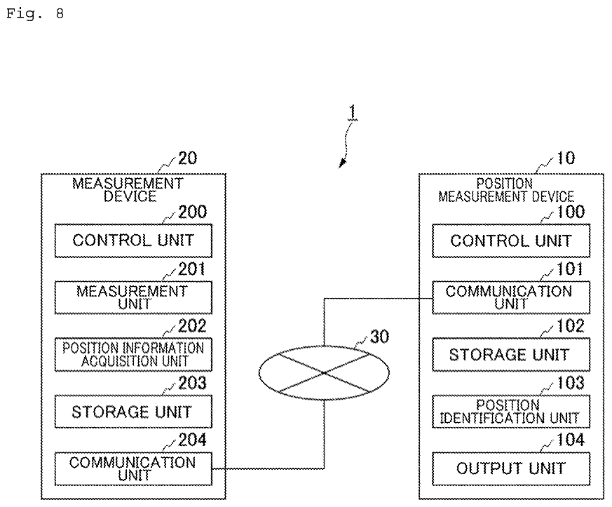

FIG. 8 is a block diagram showing the functional configuration of the position measurement system 1 in the first embodiment of the present invention. As shown in FIG. 8, the position measurement system 1 includes the position measurement device 10, the measurement device 20, and a network 30.

A functional configuration of the position measurement device 10 will be described. The position measurement device 10 is an information processing device such as a general-purpose computer, for example. The position measurement device 10 includes a control unit 100, a communication unit 101, a storage unit 102, a position identification unit 103, and an output unit 104.

The control unit 100 includes a processor such as a central processing unit (CPU), for example. The control unit 100 causes the position measurement device 10 to function as a device including the communication unit 101, the storage unit 102, the position identification unit 103, and the output unit 104 by executing a computer program stored in a storage medium such as the storage unit 102, for example.

The communication unit 101 is a communication interface for communication connection with the measurement device 20 via the network 30. The communication unit 101 includes a communication interface for wireless communication and performs communication connection with the measurement device 20 through wireless communication. The communication unit 101 may include a communication interface for wired communication and may perform communication connection with the measurement device 20 through wired communication.

The network 30 may be any data communication network as long as it can transmit three-dimensional point group data from the measurement device 20 to the position measurement device 10. For example, the network 30 may include a public network such as the Internet, and may be a virtual private network in which confidentiality is secured by a virtual private network (VPN).

The communication unit 101 acquires three-dimensional point group data transmitted from the measurement device 20. The communication unit 101 acquires a plurality of pieces of three-dimensional point group data generated by the measurement device 20 performing measurement on the same route a plurality of times. The communication unit 101 records the acquired plurality of pieces of three-dimensional point group data in the storage unit 102.

The storage unit 102 includes, for example, storage media such as a random access memory (RAM), a flash memory, an electrically erasable programmable read only memory (EEPROM), and a hard disk drive (HDD), or any combination of these storage media. The storage unit 102 stores the plurality of pieces of three-dimensional point group data acquired by the communication unit 101.

The position identification unit 103 reads the plurality of pieces of three-dimensional point group data recorded in the storage unit 102. The position identification unit 103 identifies the position and amount of an expansion gap G of the rails 60 which is a predetermined detection target position on the basis of differences between measurement positions for each of a plurality of measurements performed by the measurement device 20 indicated by the read plurality of pieces of three-dimensional point group data.

More specifically, the position identification unit 103 performs processing of superposing the aforementioned plurality of pieces of three-dimensional point group data. As described above, the plurality of pieces of three-dimensional point group data are the same in that they are a set of position data of measurement positions around the same route because of, for example, different measurement start positions (initial positions), but the measurement positions included in the three-dimensional point group data are different for each piece of three-dimensional point group data. By using this point, the position identification unit 103 identifies the position and the expansion gap amount of the expansion gap G of the rails 60 using three-dimensional point group data having a density increased by superposition of the plurality of pieces of three-dimensional point group data.

The position identification unit 103 determines whether or not a measurement position corresponding to each piece of position data is a position on the surface of the rails 60 on the basis of a position in the height direction indicated by each piece of position data included in the three-dimensional point group data. As described above, a measurement position on the surface of the rails 60 is higher than a measurement position other than the surface of the rails 60 by approximately the height of the rails 60. The height of each measurement position other than the surface of the rails 60 is approximately the height of the surface of the sleepers.

The position identification unit 103 determines whether or not a measurement position identified as a position other than the surface of the rails 60 is a position within the range of the expansion gap G on the basis of the identified position on the surface of the rails 60. A measurement position which is not within the range of the expansion gap G is not a measurement position corresponding to a position along any one of the two rails 60 and is a measurement position corresponding to any position inside or outside the two rails 60. A position on either the inside or the outside of the two rails 60 is a position shifted from the position of the rails 60 in the cross-sectional direction.

The position identification unit 103 identifies a lower limit value of the expansion gap amount of the expansion gap G of the rails 60 on the basis of two measurement positions closest to front and rear rails having the expansion gap G sandwiched therebetween among measurement positions identified as positions within the range of the expansion gap G. That is, the position identification unit 103 identifies the lower limit value of the expansion gap amount of the expansion gap G of the rails 60 on the basis of a foremost measurement position in the traveling direction D of the train 50 and a rearmost measurement position in the traveling direction D of the train 50 among measurement positions identified as positions within the range of the expansion gap G.

Further, the position identification unit 103 identifies a measurement position closest to the range of the expansion gap G for each of front and rear rails having the expansion gap G sandwiched therebetween among measurement positions identified as positions on the surface of the rail 60. The position identification unit 103 identifies an upper limit value of the expansion gap amount of the expansion gap G of the rails 60 on the basis of the two identified measurement positions. That is, the position identification unit 103 identifies the upper limit value of the expansion gap amount of the expansion gap G of the rails 60 on the basis of a rearmost measurement position among measurement positions identified as positions on the surface of a front rail in the traveling direction D of the train 50 and a foremost measurement position among measurement positions identified as positions on the surface of a rear rail in the traveling direction D of the train 50.

Further, the position identification unit 103 narrows and identifies the rearmost position of the expansion gap G (start position of the expansion gap G) in the traveling direction D of the train 50 and the foremost position of the expansion gap G (end position of the expansion gap G) in the traveling direction D of the train 50 on the basis of the two measurement positions used to identify the lower limit value of the expansion gap amount of the expansion gap G and the two measurement positions used to identify the upper limit value of the expansion gap amount of the expansion gap G. That is, the position identification unit 103 narrows and identifies the positions of both ends (the start position and the end position) of the expansion gap G.

The position identification unit 103 outputs information indicating the identified position and expansion gap amount of the expansion gap G of the rails 60 to the output unit 104.

The output unit 104 is an output apparatus such as a liquid crystal display (LCD), for example. The output unit 104 acquires the information indicating the position and the expansion gap amount of the expansion gap G of the rails 60 output from the position identification unit 103. The output unit 104 displays the acquired information. The output unit 104 may be an output interface that outputs the acquired information to an external apparatus.

The functional configuration of the measurement device 20 will be described. The measurement device 20 is a sensor device capable of measuring the position of a surrounding object. The measurement device 20 is mounted on the train 50. For example, the measurement device 20 is installed at the upper part of the rearmost of the train 50, or the like. The measurement device 20 may be installed at any position of the train 50 as long as it can measure the position of the rails 60 while the train 50 is traveling. For example, the measurement device 20 may be installed at the upper part of the first carriage of the train 50 or the like, or at the end of an intermediate carriage of the train 50 or the like.

The measurement device 20 includes a control unit 200, a measurement unit 201, a position information acquisition unit 202, a storage unit 203, and a communication unit 204.

The control unit 200 includes, for example, a processor such as a CPU. The control unit 200 causes the measurement device 20 to function as a device including the measurement unit 201, the position information acquisition unit 202, the storage unit 203, and a communication unit 204 by executing a computer program stored in a storage medium such as the storage unit 203, for example.

The measurement unit 201 measures a relative position of a surrounding object with respect to the position thereof. The measurement unit 201 includes a laser radar (LIDAR). The measurement unit 201 emits a laser and detects reflected light reflected on the surface of a surrounding object. For example, the measurement unit 201 measures a distance from the host device to a laser reflection position (that is, measurement position) on the surface of an object on the basis of a time from when the laser is emitted to when the reflected light is detected, a phase difference between the phase of the emitted laser and the phase of the reflected light, or the like.

Then, the measurement unit 201 identifies a relative three-dimensional measurement position with respect to the position thereof, for example, on the basis of the measured distance and the angle at which the laser is emitted. Accordingly, the measurement unit 201 generates three-dimensional point group data which is a set of relative measurement positions with respect to the position thereof.

Meanwhile, any position measurement sensor may be used for the measurement unit 201 as long as it can measure a relative position of a surrounding object from the position thereof. Although the position measurement sensor included in the measurement unit 201 is a laser radar in the present embodiment, the present invention is not limited thereto. For example, the measurement unit 201 may include a sensor for measuring a position using microwaves, or the like.

The position measurement sensor included in the measurement unit 201 is not limited to a sensor that measures a position using reflection of laser or electromagnetic waves such as microwaves. For example, the position measurement sensor included in the measurement unit 201 may be a sensor that measures a position using the principle of triangulation, or the like.

The position information acquisition unit 202 acquires a position of an absolute coordinate system of the host device. The position information acquisition unit 202 includes a positioning device such as a GPS, for example.

The control unit 200 converts the three-dimensional point group data, which is generated by the measurement unit 201 and indicates relative measurement positions with respect to the position of the host device, into three-dimensional point group data indicating measurement positions of the absolute coordinate system using the position of the absolute coordinate system of the host device acquired by the position information acquisition unit 202. The control unit 200 records the converted three-dimensional point group data in the storage unit 203.

The storage unit 203 includes, for example, a storage medium such as a RAM, a flash memory, an EEPROM, or an HDD, or any combination of these storage media. The storage unit 203 stores three-dimensional point group data indicating measurement positions of the absolute coordinate system converted by the control unit 200. The storage unit 203 stores a plurality of pieces of three-dimensional point group data. The plurality of pieces of three-dimensional point group data mentioned here are a plurality of pieces of three-dimensional point group data generated by the train 50 traveling on the same traveling route a plurality of times and the measurement unit 201 measuring the surrounding of the same traveling route a plurality of times.

The communication unit 204 is a communication interface for communication connection with the position measurement device 10 via the network 30. The communication unit 204 includes a communication interface for wireless communication, and performs communication connection with the position measurement device 10 through wireless communication. The communication unit 204 may include a communication interface for wired communication and may perform communication connection with the position measurement device 10 through wired communication.

The communication unit 204 acquires a plurality of pieces of three-dimensional point group data recorded in the storage unit 203. The communication unit 204 transmits the acquired three-dimensional point group data to the position measurement device 10 via the network 30.

Although it is assumed that the communication unit 204 collectively transmits a plurality of pieces of three-dimensional point group data to the position measurement device 10 in the present embodiment, the present invention is not limited thereto. For example, the communication unit 204 may be configured to transmit three-dimensional point group data to the position measurement device 10 every time one piece of three-dimensional point group data is generated (that is, every time the train 50 travels on the travel route once).

Alternatively, for example, the communication unit 204 may be configured to transmit position data to the position measurement device 10 every time position data of each measurement position constituting three-dimensional point group data is generated. That is, in this configuration, three-dimensional point group data, which is a set of position data, is constructed on the side of the position measurement device 10.

The control unit 200 performs conversion processing for converting the three-dimensional point group data indicating the relative measurement positions with respect to the position of the host device into the three-dimensional point group data indicating the measurement positions of the absolute coordinate system in order to enable the following position measurement device 10 to perform superposition processing on a plurality of pieces of three-dimensional point group data. Therefore, if the position measurement device 10 can perform superposition processing on the plurality of three-dimensional point group data on the basis of the same reference position by another method, the aforementioned conversion processing may not be performed. For example, one absolute coordinate may be associated with each piece of three-dimensional point group data, and superposition of a plurality of pieces of three-dimensional point group data may be performed on the basis of the absolute coordinate.

Therefore, if a plurality of pieces of three-dimensional data indicating relative measurement positions with respect to the position of the host device can be superposed in the same absolute coordinate system, the measurement device 20 may not include the position information acquisition unit 202.

Although the position measurement device 10 and the measurement device 20 are connected by the network 30 in the present embodiment, the present invention is not limited thereto. For example, the position measurement device 10 and the measurement device 20 may not be connected to each other by communication, and three-dimensional point group data may be transmitted from the measurement device 20 to the position measurement device 10 through a portable storage medium. Alternatively, for example, a device in which the position measurement device 10 and the measurement device 20 are integrated may be mounted on the train 50.

[Operation of Position Measurement Device 10]

Hereinafter, an example of the operation of the position measurement device 10 in the present embodiment will be described.

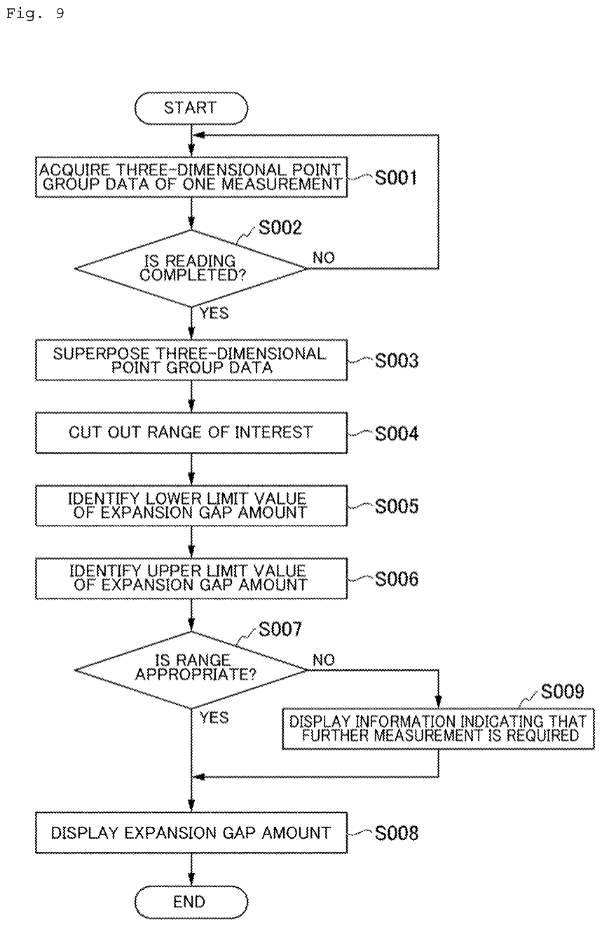

FIG. 9 is a flowchart showing the operation of the position measurement device 10 in the first embodiment of the present invention.

The position identification unit 103 acquires three-dimensional point group data of one measurement recorded in the storage unit 102 (step S001).

Three-dimensional point group data generated for each travel by the measurement device 20 mounted on the train 50 traveling a plurality of times along a predetermined same travel route is recorded in the storage unit 102. The three-dimensional point group data of one measurement is three-dimensional point group data obtained by measurement during one travel among a plurality of pieces of three-dimensional point group data recorded in the storage unit 102. Three-dimensional point group data is a set of position data indicating positions of objects around the travel route of the train 50.

If reading of all of the plurality of pieces of three-dimensional point group data recorded in the storage unit 102 is not completed (No in step S002), the position identification unit 103 repeats processing of step S001 and acquires three-dimensional point group data which has not been read yet.

If reading of all of the plurality of three-dimensional point group data recorded in the storage unit 102 is completed (Yes in step S002), the position identification unit 103 performs superposition processing on the read plurality of pieces of three-dimensional point group data, for example, as shown in FIG. 5 (step S003).

Next, the position identification unit 103 cuts out a range A of interest from the superposed three-dimensional point group data, for example, as shown in FIG. 5 (step S004). The range A of interest is cut out such that a range in which an expansion gap G is present is included therein. Although a method for determining whether or not a range is a range in which the expansion gap G is present is arbitrary, the method is performed on the basis of the position in the height direction of a measurement position included in three-dimensional point group data, for example.

The position identification unit 103 determines whether or not a measurement position corresponding to each piece of position data is a position on the surface of the rails 60 on the basis of a position in the height direction indicated by each piece of position data included in the three-dimensional point group data. As described above, a measurement position on the surface of the rails 60 is higher than each measurement position other than the surface of the rails 60 by approximately the height of the rails 60. The height of each measurement position other than the surface of the rails 60 is approximately the height of the surface of the sleepers.

Further, the position identification unit 103 determines whether or not a measurement position identified as a position other than the surface of the rails 60 is a position within the range of the expansion gap G on the basis of the identified position on the surface of the rails 60. As described above, a measurement position which is not within the range of the expansion gap G is not a measurement position present on the locus of either one of the two rails 60 but is a measurement position present on either the inside or the outside of the two rails 60.

Next, the position identification unit 103 identifies a lower limit value of the expansion gap amount of the expansion gap G of the rails 60 on the basis of two measurement positions closest to front and rear rails having the expansion gap G sandwiched therebetween among measurement positions identified as positions within the range of the expansion gap G (step S005). That is, the position identification unit 103 identifies the lower limit value of the expansion gap amount of the expansion gap G of the rails 60 on the basis of a foremost measurement position in the traveling direction D of the train 50 and a rearmost measurement position in the traveling direction D of the train 50 among measurement positions identified as positions within the range of the expansion gap G.

Next, the position identification unit 103 identifies measurement positions closest to the range of the expansion gap G with respect to the front and rear rails having the expansion gap G sandwiched therebetween among measurement positions identified as positions on the surface of the rails 60. The position identification unit 103 identifies an upper limit value of the expansion gap amount of the expansion gap G of the rails 60 on the basis of the two identified measurement positions (step S006). That is, the position identification unit 103 identifies the upper limit value of the expansion gap amount of the expansion gap G of the rails 60 on the basis of a rearmost measurement position among measurement positions identified as positions on the surface of a front rail in the traveling direction D of the train 50 and a foremost measurement position among measurement positions identified as positions on the surface of a rear rail in the traveling direction D of the train 50.

A range of the estimated expansion gap amount is identified on the basis of the identified lower limit value and the upper limit value of the expansion gap amount. The position identification unit 103 determines whether or not the identified range of the expansion gap amount is an appropriate range (step S007). The appropriate range mentioned here is a range in which management at least in units of millimeters required for management of the expansion gap amount can be performed. That is, when the difference between the identified lower limit value and upper limit value of the expansion gap amount is equal to or less than 1 [mm], for example, it is determined that the identified range of the expansion gap amount is an appropriate range.

If it is determined that the identified range of the expansion gap amount is an appropriate range (Yes in step S007), the output unit 104 displays information indicating the identified range of the expansion gap amount (step S008). On the other hand, if it is determined that the identified range of the expansion gap amount is not an appropriate range (No in step S007), the output unit 104 displays information indicating that further measurement is required (step S009).

A case where further measurement is required is a case where superposition of more three-dimensional point group data is required. Therefore, it is necessary to cause the train 50 to further travel on the predetermined travel route and cause the measurement device 20 to further generate three-dimensional point group data for the same travel route.

In this manner, the operations of the position measurement device 10 shown in the flowchart of FIG. 9 ends.

As described above, in the position measurement device 10 in the first embodiment of the present invention, the measurement device 20 mounted on the train 50 moves along a predetermined travel route of the train 50. The measurement device 20 sequentially measures positions of rails, sleepers, the ground surface, and the like which are surrounding objects while moving. The measurement device 20 generates three-dimensional point group data based on measurement results. The position measurement device 10 acquires three-dimensional point group data generated by the measurement device 20. At this time, the position measurement device 10 acquires a plurality of pieces of three-dimensional point group data generated by performing measurement on the same travel route of the train 50 a plurality of times. The position measurement device 10 identifies the position and the expansion gap amount of the expansion gap G on the basis of differences between measurement positions generated in measurement performed a plurality of times using the plurality of pieces of three-dimensional point group data.

Since variations are present in measurement positions in the plurality of pieces of three-dimensional point group data, the position measurement device 10 can identify the position of the expansion gap G using a larger amount of three-dimensional point group data in a measurement target range (for example, the range A of interest). Accordingly, the position measurement device 10 can improve the measurement accuracy of the position and the expansion gap amount of the expansion gap G.

### Modified Example of First Embodiment

Hereinafter, a modified example of the first embodiment of the present invention will be described.

In the first embodiment described above, one measurement device 20 is installed, for example, at the upper center of the rearmost part of the train 50. In addition, the measurement device 20 measures the surroundings of the same travel route a plurality of times when the train 50 travels on the same travel route a plurality of times. Accordingly, a plurality of pieces of three-dimensional point group data in the same travel route are generated.

In a modified example of the first embodiment, a plurality of measurement devices are mounted on a moving body. When the moving body moves once along a predetermined route, the plurality of measurement devices mounted on the moving body measure positions of objects around the route. Accordingly, a plurality of pieces of three-dimensional point group data in the same route are generated by one movement of the moving body.

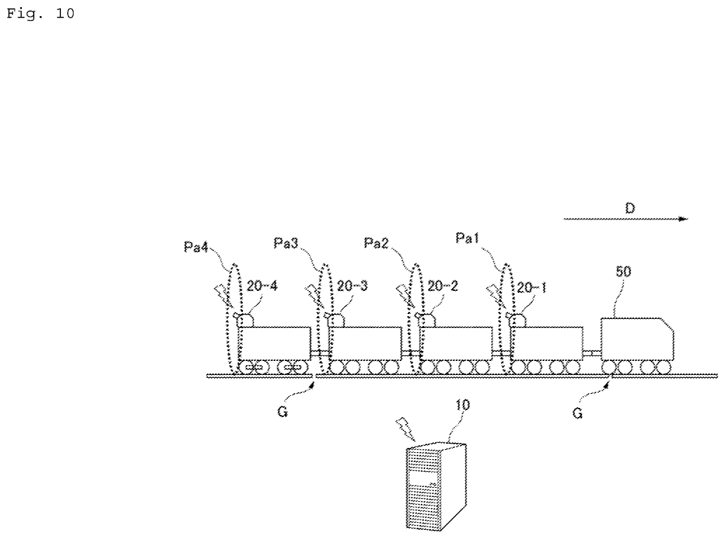

FIG. 10 is a diagram for describing a position measurement method in the modified example of the first embodiment of the present invention. Similarly to the above-described first embodiment, the moving body is a train 50 and the predetermined route is a track including rails 60 in this modified example. In this modified example, the track is, for example, a ballast track.

As shown in FIG. 10, a plurality of measurement devices 20 (measurement devices 20-1 to 20-4) are mounted on the train 50 which is a moving body. The train 50 travels on the track in a traveling direction D shown in FIG. 10, for example.

As shown in FIG. 10, the measurement devices 20 (measurement devices 20-1 to 20-4) are respectively installed at the upper centers of the rearmost parts of carriages of the train 50, for example. Accordingly, position data acquisition positions Pa (Pa1 to Pa4) corresponding to the respective measurement devices 20 (measurement devices 20-1 to 20-4) are formed. As described above, the position data acquisition positions Pa1 to Pa4 are sets of position data acquisition positions acquired by the measurement devices 20-1 to 20-4.

The plurality of measurement devices 20 (measurement devices 20-1 to 20-4) move as the train 50 travels on the track. Each of the measurement devices 20 (measurement devices 20-1 to 20-4) sequentially measure positions of surrounding objects while moving.

Each of the measurement devices 20 (measurement devices 20-1 to 20-4) generates three-dimensional point group data based on measurement results. The generated point group data is not limited to three-dimensional point group data and may be two-dimensional point group data. Each of the measurement devices 20 (measurement devices 20-1 to 20-4) transmit the generated three-dimensional point group data to the position measurement device 10 wirelessly, for example.

With the above-described configuration, the position measurement system in the modified example of the first embodiment of the present invention can generate a plurality of pieces of three-dimensional point group data on the same travel route only by one travel of the train 50. In addition, the position measurement system can accurately identify the position and the expansion gap amount of the expansion gap G of the rails 60 only by one travel of the train 50.

### Second Embodiment

Hereinafter, a modified example of second embodiment of the present invention will be described.

The above-described position measurement system 1 in the first embodiment superposes a plurality of pieces of three-dimensional point group data generated by performing measurement on the same route a plurality of times to increase the density of the three-dimensional point group data. Then, on the basis of a position in the height direction of a measurement position included in the three-dimensional point group data, the position measurement system 1 determines whether the measurement position is a position on the surface of the rails 60, a position within the range of an expansion gap, or other positions.

At this time, the position measurement system 1 is configured to identify a range estimated to be a boundary position between a rail 60 and the expansion gap G on the basis of a measurement position which is determined to be a position on the surface of the rail 60 and is closest to the expansion gap G and a measurement position which is determined to be within the range of the expansion gap G and is closest to the rail 60. Then, when the estimated range does not satisfy required measurement accuracy (for example, accuracy in units of millimeters), the position measurement system 1 requests three-dimensional point group data generated by measurement again.

On the other hand, the position measurement system in the second embodiment which will be described below superposes a plurality of pieces of point group data generated by performing measurement on the same route a plurality of times to increase the density of the three-dimensional point group data first as in the first embodiment. Next, the position measurement system performs arithmetic operation processing which will be described below while moving (sliding) a predetermined small region (hereinafter referred to as a “section”) on a measurement target region. At this time, the position measurement system uses, for example, a rectangular region as the predetermined small region.

Next, the position measurement system in the second embodiment performs addition averaging processing (composite processing) for adding and averaging positions in the height direction of a plurality of measurement positions present within a section every time the section is slid by a predetermined distance (hereinafter referred to as an “addition averaging processing interval”). Accordingly, superposed three-dimensional point group data is converted so as to be one piece of position data for each addition averaging processing interval. At this time, the position measurement system sets the center position of each section as a position on a horizontal plane and associates the center position with an added and averaged position in the height direction to obtain converted three-dimensional point group data.

It is desirable that the aforementioned addition averaging processing interval be a length approximately equal to a required measurement accuracy (for example, several millimeters).

Then, the position measurement system in the second embodiment identifies the position and the expansion gap amount of the expansion gap G on the basis of change in the position in the height direction indicated by the converted three-dimensional point group data.

In the first embodiment described above, the position measurement system 1 identifies a range estimated to be a boundary position between the rails 60 and the expansion gap G. Therefore, when the number of times of measurement is small, for example, the range estimated to be the boundary position between the rails 60 and the expansion gap G is excessively wide, and thus it is difficult to uniquely estimate the position of the expansion gap G. On the other hand, the position measurement system in the second embodiment can uniquely estimate the position of the expansion gap G through addition averaging processing even when the number of times of measurement is small, for example, if at least one measurement position is included in a section.

Hereinafter, a specific example will be described.

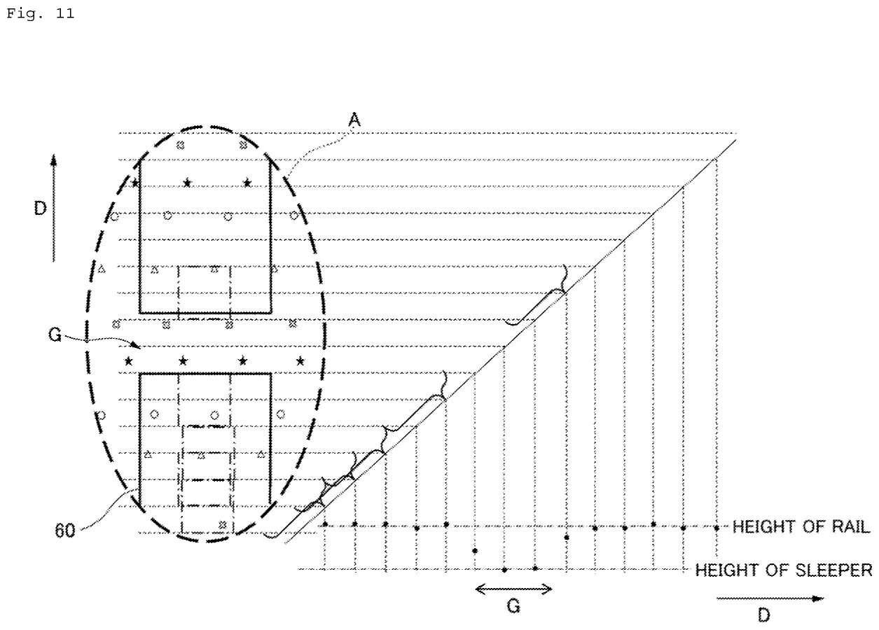

FIG. 11 is a diagram for describing processing of identifying the position and the expansion gap amount of the expansion gap G by the position measurement system in the second embodiment of the present invention.

FIG. 11 includes a plan view of a range A of interest viewed from above like FIG. 6. Further, the above-mentioned section is represented in a rectangular form by alternate long and short dash lines in FIG. 11. In FIG. 11, the above-mentioned predetermined addition averaging processing interval is indicated by a broken line.

The position measurement system in the second embodiment performs addition averaging processing on a position in the height direction of a measurement position included in a section at the predetermined addition averaging processing interval. On the right side of FIG. 11, a state in which results of addition averaging processing for each section are sequentially plotted and visualized.

As shown in FIG. 11, at a position where an entire section is located on the surface of the rails 60, results of addition averaging processing have a height approximately equal to the height of the rails 60. Further, at a position where an entire section is within the range of the expansion gap G, results of addition averaging processing have a height approximately equal to the height of the sleepers. Further, at a position where a section straddles a position on the surface of the rails 60 and a position within the range of the expansion gap G, results of addition averaging processing have a height between the height of the rails 60 and the height of the sleepers.

The position measurement system in the second embodiment identifies the position and the expansion gap amount of the expansion gap G on the basis of results of addition averaging processing. For example, the position measurement system compares a position in the height direction based on the results of addition averaging processing with a predetermined threshold value. For example, the threshold value is set to an intermediate height between the height of the position of the surface of the rails 60 and the height of the sleepers. The position measurement system determines whether a measurement position corresponding to a target section (for example, a position at the center of the section) is a position on the surface of the rails 60, a position within the range of the expansion gap G, or another position on the basis of comparison results.

That is, the position measurement system in the second embodiment determines that the measurement position corresponding to the target section (for example, the position at the center of the section) is a position on the surface of the rails 60, for example, when the position in the height direction based on the results of addition averaging processing is a position equal to or greater than the predetermined threshold value. For example, the position measurement system determines that the measurement position corresponding to the target section is a position other than the surface of the rails 60 when the position in the height direction based on the results of addition averaging processing is a position less than the predetermined threshold value. Further, for example, the position measurement system determines whether or not the measurement position corresponding to the target section is a position within the range of the expansion gap G on the basis of whether the measurement position is a position along the rails 60 when it is determined that the measurement position is a position other than the surface of the rails 60.

The position measurement system identifies the position and the expansion gap amount of the expansion gap G on the basis of a position determined to be the surface of the rails 60 and a position determined to be within the range of the expansion gap G.

The position measurement system may identify the position and the expansion gap amount of the expansion gap G using a method different from the aforementioned method that identifies the position and the expansion gap amount of the expansion gap G according to comparison with the threshold value. For example, when the position in the height direction obtained from the results of addition averaging processing is lower than the height of the surface position of the rails 60 and higher than the height of the sleepers, the position measurement system may determine that the measurement position corresponding to the target section (for example, the position at the center of the section) is a position corresponding to the boundary between the expansion gap G and the rails 60.

The height lower than the height of the surface position of the rails 60 and higher than the height of the sleepers, used here, may be set to, for example, a height lower than the height of the surface position of the rails 60 by 5 [mm] or more and higher than the height of the sleepers by 5 [mm] or more. Accordingly, a measurement error of about 5 [mm] in the height direction is absorbed.

The position measurement system in the second embodiment displays information indicating that further measurement is required if there is a section including two or less measurement positions. However, the present invention is not limited to this configuration. For example, the position measurement system may display information indicating that further measurement is required when there is a section including a predetermined number of measurement positions or less (for example, 3 or less measurement positions). Alternatively, for example, the position measurement system may display information indicating that further measurements are required when there is a section having no measurement position.

Although three-dimensional point group data of four measurements is used here in order to make the description easy to understand, more measurements are actually required. This is because the expansion gap amount is set, for example, in the range of 1.6 [mm] to 7.9 [mm] and management at least in units of millimeters is required, as described above. On the other hand, with the laser radar in the present embodiment, only three-dimensional point group data having an accuracy of 10 [cm] in the traveling direction D of the train 50 can be obtained.

Accordingly, a case in which no measurement position is present within the range of the expansion gap G only by four measurements, for example, may also be conceived. Therefore, it is difficult to perform management in units of millimeters using only three-dimensional point group data obtained by four measurements. In practice, it is necessary to use a large amount of three-dimensional point group data obtained by performing measurement at least about 10 times, preferably about 100 times.

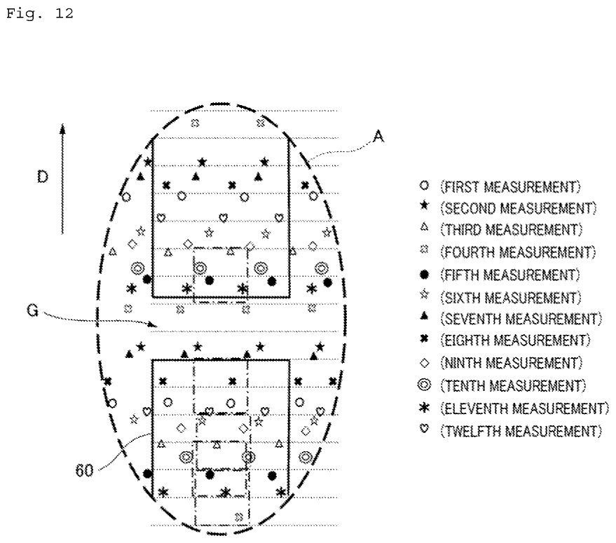

For example, when 12 pieces of three-dimensional point group data generated by performing measurement on the same route 12 times are superposed as in FIG. 7, the superposition is as shown in FIG. 12.

FIG. 12 is a diagram for describing processing of identifying the position and the expansion gap amount of the expansion gap G by the position measurement system in the second embodiment of the present invention. FIG. 12 includes a plan view of the same range A of interest as that shown in FIG. 7 viewed from above. Further, the above-mentioned section is represented in a rectangular form by alternate long and short dash lines in FIG. 12. In FIG. 12, the above-mentioned predetermined addition averaging processing interval is indicated by a broken line.

The position measurement system in the second embodiment performs addition averaging processing on a position in the height direction of a measurement position included in a section at the predetermined addition averaging processing interval. When the number of measurement positions present in a section shown in FIG. 12 is compared with the number of measurement positions present in a section shown in FIG. 11, the number of measurement positions present in the section shown in FIG. 12 is larger. This is because the number of times of measurement is greater in the case of FIG. 12 than in the case of FIG. 11.

In this manner, when the number of times of measurement is larger, a position in the height direction of a measurement position calculated by addition averaging processing becomes a more accurate value. Further, when the number of times of measurement is larger, the possibility of occurrence of a case where there is no measurement position in the range of the expansion gap G or a case where there is a section including only a predetermined number of measurement positions or less (for example, less than three measurement positions) in the range is reduced, and thus the possibility of occurrence of a situation in which further measurement is required is reduced.

Further, when the number of times of measurement is larger, the addition averaging processing interval can be further reduced. Accordingly, the position measurement system can identify the position and the expansion gap amount of the expansion gap G using position data at a finer addition averaging processing interval. Further, when the number of times of measurement is larger, the size of the section can be further reduced (for example, the length of each side of the section, which is a rectangular region, can be further reduced). Accordingly, the position measurement system can identify the position and the amount of the expansion gap G using a plurality of pieces of position data present in a narrower range.

As in the modified example of the first embodiment, a plurality of measurement devices may be mounted on a moving body (for example, the train 50), and when the moving body moves once along a predetermined route, the plurality of measurement devices mounted on the moving body may measure positions of objects around the route (for example, rails 60) in the second embodiment. Accordingly, a plurality of pieces of three-dimensional point group data in the same route are generated by one movement of the moving body.

In the present embodiment, the position measurement system performs addition averaging processing (composite processing) for adding and averaging positions in the height direction of a plurality of measurement positions present in a section. However, the present invention is not limited to this configuration. For example, the position measurement system may be configured to perform convolution processing instead of addition averaging processing. For example, the position measurement system may be configured to perform processing for integrating positions in the height direction of measurement positions close to the center part of a section by making weighting to the positions larger than weighting to positions in the height direction of measurement positions close to the edge part of the section instead of simply adding and averaging positions in the height direction of a plurality of measurement positions present in the section.

The block diagram showing the functional configuration of the position measurement system in the second embodiment is basically the same as the block diagram showing the functional configuration of the position measurement system 1 in the first embodiment shown in FIG. 8. Therefore, detailed description thereof will be omitted. Hereinafter, each functional unit of the position measurement system in the second embodiment will be described by being denoted by the same reference sign as that attached to each functional unit of the position measurement system 1 in the first embodiment shown in FIG. 8.

[Operation of Position Measurement Device]

Hereinafter, an example of the operation of the position measurement device in the present embodiment will be described.

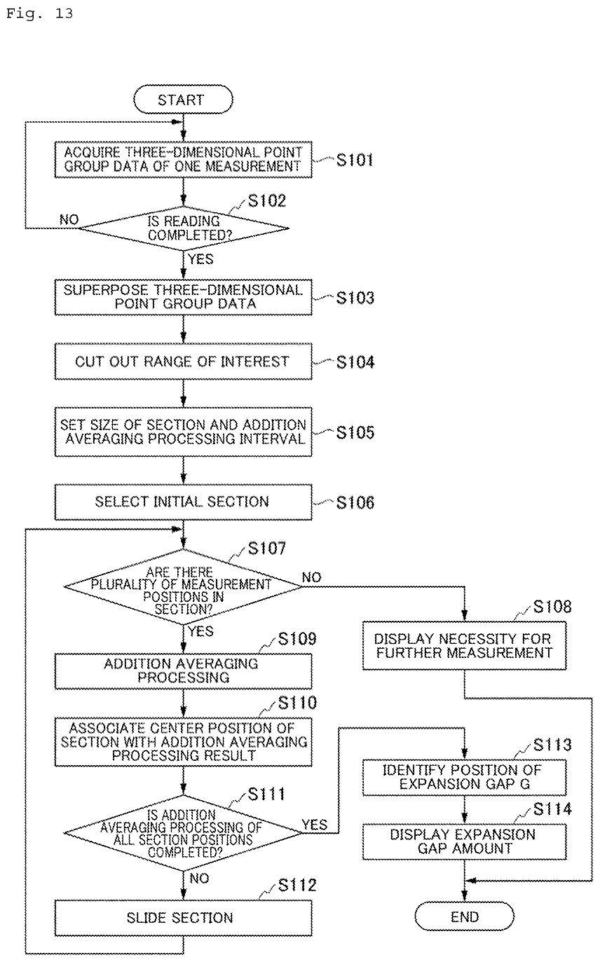

FIG. 13 is a flowchart showing the operation of the position measurement device in the second embodiment of the present invention.

The position identification unit 103 acquires three-dimensional point group data of one measurement recorded in the storage unit 102 (step S101).

Three-dimensional point group data generated for each travel by the measurement device 20 mounted on the train 50 traveling a plurality of times along a predetermined same travel route is recorded in the storage unit 102. The three-dimensional point group data of one measurement is three-dimensional point group data obtained by measurement during one travel among a plurality of pieces of three-dimensional point group data recorded in the storage unit 102. Three-dimensional point group data is a set of position data indicating positions of objects around the travel route of the train 50.

If reading of all of the plurality of pieces of three-dimensional point group data recorded in the storage unit 102 is not completed (No in step S102), the position identification unit 103 repeats processing of step S101 and acquires three-dimensional point group data which has not been read yet.

If reading of all of the plurality of pieces of three-dimensional point group data recorded in the storage unit 102 is completed (Yes in step S102), the position identification unit 103 performs processing of superposing the read plurality of pieces of three-dimensional point group data (step S103).

Next, the position identification unit 103 cuts out a range A of interest from the superposed three-dimensional point group data, for example, as shown in FIG. 11 or FIG. 12 (step S104). The range A of interest is cut out such that a range in which an expansion gap G is present is included therein.

Next, the position identification unit 103 sets a size of a section and an addition averaging processing interval (S105). The section is set, for example, as a rectangular region in which the length of each side is arbitrary. In addition, the addition averaging processing interval is an interval for sliding a section as described above. It is desirable that the addition averaging processing interval be set to a length of about the same degree (for example, several millimeters) as a required measurement accuracy.

Next, the position identification unit 103 selects a section to be subjected to addition averaging processing first (step S106). For example, the position identification unit 103 may scan the range of interest through a method of sequentially sliding a section in the cross-sectional direction (that is, to the right) first from the lower left position of the range A of interest shown in FIG. 11 or 12, sliding the section in the traveling direction D of the train 50 by the addition averaging processing interval when sliding in the cross-sectional direction is completed, and sequentially sliding the section again in the cross-sectional direction (that is, to the right).

Next, the position identification unit 103 determines whether or not a plurality of measurement positions are present in the selected section (step S107). If the number of measurement positions present in the selected section is one or less (No in step S107), the output unit 104 displays information indicating that further measurement is required (step S108). In this manner, the operation of the position measurement device 10 shown in the flowchart of FIG. 13 ends.

On the other hand, if a plurality of measurement positions are present in the selected section (Yes in step S107), the position identification unit 103 performs addition averaging processing (composite processing) for adding and averaging positions in the height direction of the plurality of measurement positions present in the section (step S109).

Next, the position identification unit 103 associates the center position of the section with a position on the horizontal plane and a position in the height direction determined as a result of addition average processing (step S110). Accordingly, position data indicating the plurality of measurement positions present in the section is converted into one piece of position data representing the section.

The position identification unit 103 performs addition averaging processing at all positions that can be taken by the section sliding at every addition average processing interval within the range A of interest. If there is a section position where addition averaging processing is not performed (No in step S111), the position identification unit 103 slides the section (step S112) and repeats processing after step S107.

On the other hand, if addition averaging processing is completed for all the section positions (Yes in step S111), the position identification unit 103 identifies the position of an expansion gap G (step S113). For example, the position identification unit 103 compares a position in the height direction based on results of addition averaging processing with a predetermined threshold value. For example, the threshold value is set to an intermediate height between the height of the surface position of the rails 60 and the height of the sleepers. The position identification unit 103 determines whether a measurement position corresponding to the target section (that is, the center position of the section) is a position on the surface of the rails 60, a position within the range of the expansion gap G, or another position on the basis of a comparison result. The position identification unit 103 identifies the position of the expansion gap G on the basis of a position determined to be a position of the surface of the rails 60 and a position determined to be within the range of the expansion gap G.

For example, the position identification unit 103 identifies positions of both ends (start position and end position) of the expansion gap G on the basis of change in positions in the height direction of two section positions adjacent to each other in the traveling direction D of the train 50.

Next, the position identification unit 103 identifies an expansion gap amount on the basis of the identified position of the expansion gap G. For example, the position identification unit 103 identifies a distance between the identified positions of both ends (start position and end position) of the expansion gap G as the expansion gap amount.

Next, the output unit 104 displays information indicating the identified expansion gap amount (step S114).

In this manner, the operation of the position measurement device 10 shown in the flowchart of FIG. 13 ends.

As described above, first, the position measurement system in the second embodiment of the present invention superposes a plurality of pieces of three-dimensional point group data generated by performing measurement on the same route a plurality of times to increase the density of the three-dimensional point group data as in the first embodiment. Next, the position measurement system performs addition averaging processing (composite processing) for adding and averaging positions in the height direction of a plurality of measurement positions present in a section that is a predetermined small rectangular region while moving (sliding) the section on a measurement target region (for example, range A of interest).

The position measurement device in the second embodiment performs addition averaging processing every time the section is slid by an addition averaging processing interval which is a predetermined interval. Accordingly, the superposed three-dimensional point group data is converted into one piece of position data for each addition averaging processing interval. At this time, the position measurement device sets the center position of each section as a position on the horizontal plane and associates the center position with the added and averaged position in the height direction to obtain converted three-dimensional point group data. Then, the position measurement system in the second embodiment identifies the position and the expansion gap amount of the expansion gap G on the basis of change in the position in the height direction indicated by the converted three-dimensional point group data.

Since variations exist in measurement positions in a plurality of pieces of three-dimensional point group data, the position measurement device in the second embodiment can identify the position of the expansion gap G using a larger amount of three-dimensional point group data in a measurement target range (for example, range A of interest). Accordingly, the position measurement device can improve measurement accuracy of the position and the expansion gap amount of the expansion gap G.

Further, the position measurement device in the second embodiment can uniquely estimate the position of the expansion gap G by addition averaging processing even when the number of measurements is small, for example, if at least one measurement position is included in a section.

According to each embodiment described above, the position measurement device includes an acquisition unit and a position identification unit. For example, the position measurement device is the position measurement device 10 in the embodiments, the acquisition unit is the communication unit 101 in the embodiments, and the position identification unit is the position identification unit 103 in the embodiments.

The acquisition unit acquires a plurality of pieces of point group data generated by being measured at different timings with respect to the same route. For example, the route is a track including the rails 60 in the embodiments, and the point group data is three-dimensional point group data in the embodiments. The point group data is measured by a measurement unit moving along a predetermined route and indicates a position of an object around the route. For example, the measurement unit is the measurement unit 201 in the embodiments, the object around the route is a rail 60, a sleeper, a ground surface, or the like, and the position is a measurement position in the embodiments.

The position identification unit identifies a detection target position indicating a position of a predetermined object present around the route on the basis of a difference in position for each of the plurality of pieces of point group data. For example, the difference in position is a difference in measurement positions included in the plurality of pieces of point group data, which is caused by a difference (variation) in measurement start position in the embodiment, and the detection target position is the position of the expansion gap G in the embodiments.

The plurality of pieces of point group data may be generated by the measurement unit repeating movement along the route a plurality of times.

Alternatively, the plurality of pieces of point group data may be generated by a plurality of measurement units moving along the route.

The position identification unit may identify the detection target position on the basis of an interval between two closer measurement positions included in different pieces of point group data.

Alternatively, the position identification unit may move a section having a predetermined size in a measurement target range at every predetermined distance and identify the detection target position on the basis of an addition averaging value of a plurality of measurement positions included in the section. For example, the measurement target range is the range A of interest in the embodiments, and the predetermined distance is the addition averaging processing interval in the embodiments.

A part of the position measurement system in each of the above-described embodiments may be realized as a computer. In such a case, a program for realizing this function may be recorded in a computer-readable recording medium, and the function may be realized by reading the program recorded on this recording medium to a computer system and executing the program. It is assumed that the “computer system” mentioned here include an OS and hardware such as peripheral devices. In addition, the “computer-readable recording medium” refers to a portable medium such as a flexible disk, a magneto-optical disk, a ROM, or a CD-ROM, or a storage device such as a hard disk that is built in the computer system. Furthermore, the “computer-readable recording medium” may also include a recording medium that dynamically holds a program for a short period of time such as a communication wire when the program is to be transmitted via a network such as the Internet or a communication line such as a telephone line as well as a recording medium that holds a program for a certain period of time such as a volatile memory inside a server or a computer system to become a client. Moreover, the program described above may be any of a program for realizing a part of the functions described above, a program capable of realizing the functions described above in combination with a program already recorded in a computer system, and a program for realizing the functions using a programmable logic device such as a field programmable gate array (FPGA).

Although the embodiments of the present invention have been described in detail with reference to the drawings, specific configurations are not limited to these embodiments, and designs and the like within a range that does not deviating from the gist of the present invention are also included.

### REFERENCE SIGNS LIST

1 Position measurement system, 10 Position measurement device, 20 (20-1 to 20-4) Measurement device, 30 Network, 50 Train, 60 Rail, 100 Control unit, 101 Communication unit, 102 Storage unit, 103 Position identification unit, 104 Output unit, 200 Control unit, 201 Measurement unit, 202 Position information acquisition unit, 203 Storage unit, 204 Communication unit

1. A position measurement method comprising: a point group data generation step of generating point group data indicating a position of an object around a predetermined route measured by a measurement unit moving along the route;
an acquisition step of acquiring a plurality of pieces of point group data generated by being measured at different timings with respect to the same route; and
a position identification step of identifying a detection target position indicating a position of a predetermined object present around the route on the basis of a difference in the position for each of the plurality of pieces of point group data.

2. The position measurement method according to claim 1,
wherein the plurality of pieces of point group data are generated by the measurement unit repeating movement along the route a plurality of times.

3. The position measurement method according to claim 1,
wherein the plurality of pieces of point group data are generated by a plurality of measurement units moving along the route.

4. The position measurement method according to claim 1, wherein the position identification step identifies the detection target position on the basis of an interval between two closer positions included in different pieces of point group data.

5. The position measurement method according to claim 1, wherein the position identification step moves a section having a predetermined size in a measurement target range for each predetermined distance, calculates an addition averaging value of a plurality of measurement positions included in the section for each movement of the section, and identifies the detection target position on the basis of the addition averaging value.

6. The position measurement method according to claim 1, wherein the measurement unit is mounted on a train, and the route is a track.

7. The position measurement method according to claim 1, wherein the detection target position is a position of an expansion gap of rails.

8. A position measurement device comprising: an acquisition unit configured to acquire a plurality of pieces of point group data which indicate positions of objects around a predetermined route measured by a measurement unit moving along the route and are generated by being measured at different timings with respect to the same route; and
a position identification unit configured to identify a detection target position indicating a position of a predetermined object present around the route on the basis of a difference in the position for each of the plurality of pieces of point group data.
